(19) United States
(12) Patent Application Publication
(10) Pub. No.: US 2024/0393446 A1
(43) Pub. Date: Nov. 28, 2024

(54) PROJECTILE TRACKING METHOD USING PSEUDO-NOISE CODE, AND DEVICE THEREFOR

(71) Applicant: DANAM SYSTEMS INC., Anyang-si (KR)

(72) Inventors: Seong Min KIM, Seoul (KR); Jong Hyuk LEE, Anyang-si (KR); Bokki KIM, Seoul (KR)

(21) Appl. No.: 18/692,062

(22) PCT Filed: Aug. 7, 2023
(86) PCT No.: PCT/KR2023/011586

§ 371 Date: Mar. 14, 2024

(30) Foreign Application Priority Data
Aug. 8, 2022 (KR) 10-2022-0098629

(51) Int. Cl. G01S 11/08; H04L 5/00; H04W 64/00

(52) U.S. Cl. CPC G01S 11/08; H04L 5/0048; H04W 64/003

(57) ABSTRACT

Disclosed are a projectile tracking method using a pseudo random noise code and an apparatus therefor. A projectile tracking system which tracks a projectile using a pseudo random noise code according to an exemplary embodiment of the present invention includes a beacon processing device which is provided in a projectile to acquire a tracking packet signal and generates and transmits a response packet signal based on a pseudo random noise code included in the tracking packet signal; and a ground tracking device which transmits the tracking packet signal to the projectile, acquires the response packet signal, calculates a transmission/reception delay time using a packet reception time determined based on a timing error for the response packet signal, and calculates a distance from the projectile using the transmission/reception delay time to track a flight trajectory of the projectile.

### TECHNICAL FIELD

The present invention relates to a projectile tracking method using a pseudo random noise code to track a flight trajectory and an apparatus therefor

### BACKGROUND ART

The contents described in this section merely provide background information on the exemplary embodiment of the present disclosure, but do not constitute the related art.

A distance between two systems may be easily calculated by exchanging global positioning system (GPS) coordinates between two systems. However, when there is no support of the GPS or the GPS cannot be used due to jamming, a wireless distance measurement technique which uses a wireless transmission propagation delay characteristic is used to measure the distance between two systems. The wireless distance measurement technology is also used for various commercial or military purposes, such as positioning systems, navigations, or telemetry.

A general ground tracking device transmits a tracking packet signal (RF signal) which is modulated with a previously agreed double pulse toward a beacon processing device mounted in a projectile.

The beacon processing device receives a tracking packet signal and measures a pulse interval of pulses extracted from the tracking packet signal, and then confirms whether the pulse is an agreed pulse. When it is confirmed that the pulse is the agreed pulse, the beacon processing device transmits an RF signal having a frequency different from that of a tracking packet signal modulated with a single pulse as a response packet signal.

The ground tracking device calculates a distance between the ground tracking device and the projectile by means of time delay of the transmission/reception pulse (a tracking packet signal and a response packet signal).

The ground tracking device calculates a response time of a pulse by detecting a period for a pulse rising time. The ground tracking device detects a pulse rising edge in a condition in which a signal sensitivity is equal to or higher than a predetermined reference to determine a period for the pulse rising time.

The ground tracking device requires a power peak of a predetermine reference or higher for precision of the pulse rising time and there is a limitation to increasing precision for distance measurement by increasing a peak power.

### DISCLOSURE

### Technical Problem

A main object of the present invention is to provide a projectile tracking method using a pseudo random noise code which transmits a pseudo random noise code based tracking packet signal to a projectile from a ground tracking device, receives a pseudo random noise code based response packet signal from the projectile, corrects a transmission/reception delay time of a packet using the response packet signal in the ground tracking device to calculate a distance between the ground tracking device and the projectile to track a flight trajectory of the projectile and an apparatus therefor.

### Technical Solution

According to an aspect of the present invention, in order to achieve the above-described objects, a projectile tracking system using a pseudo random noise code includes: a beacon processing device which is provided in a projectile to acquire a tracking packet signal and generates and transmits a response packet signal based on a pseudo random noise code included in the tracking packet signal; and a ground tracking device which transmits the tracking packet signal to the projectile, acquires the response packet signal, calculates a transmission/reception delay time using a packet reception time determined based on a timing error for the response packet signal, and calculates a distance from the projectile using the transmission/reception delay time to track a flight trajectory of the projectile.

Further, according to another aspect of the present invention, in order to achieve the above-described objects, a projectile tracking method using a pseudo random noise code in a projectile tracking system including a ground tracking device and a projectile including a beacon processing device includes: transmitting a tracking packet signal from the ground tracking device to the projectile; acquiring the tracking packet signal by the beacon processing device; generating and transmitting a response packet signal based on a pseudo random noise code included in the tracking packet signal in the beacon processing device; acquiring the response packet signal in the ground tracking device; and tracking a flight trajectory of the projectile by calculating a transmission/reception time using a packet reception time determined based on a timing error for the response packet signal and calculating a distance from the projectile using the transmission/reception delay time in the ground tracking device.

### Advantageous Effects

As described above, according to the present invention, the ground tracking device transmits a pseudo random noise code based tracking packet signal to a projectile, receives a pseudo random noise code based response packet signal from the projectile, corrects a transmission/reception delay time of a packet using the response packet signal to calculate a distance between the ground tracking device and the projectile to track a flight trajectory of the projectile, thereby improving a distance measurement precision to calculate a distance between the ground tracking device and the projectile.

Further, according to the present invention, an equal or better precision can be achieved even with approximately 1/100 of a transmission power of a method based on the detection of a pulse rising edge.

The effects of the present disclosure are not limited to the technical effects mentioned above, and other effects which are not mentioned can be clearly understood by those skilled in the art from the following description

### BRIEF DESCRIPTION OF THE DRAWINGS

FIG. 1 is a block diagram schematically illustrating a projectile tracking system according to an exemplary embodiment of the present invention.

FIG. 2 is a block diagram schematically illustrating a ground tracking device according to an exemplary embodiment of the present invention.

FIG. 3 is a block diagram schematically illustrating a beacon processing device of a projectile according to an exemplary embodiment of the present invention.

FIG. 4 is a block diagram schematically illustrating a hardware configuration of a beacon processing device according to an exemplary embodiment of the present invention.

FIG. 5 is a flowchart for explaining a projectile tracking method according to an exemplary embodiment of the present invention.

FIG. 6 is a view for explaining a beacon processing method of the related art.

FIG. 7 is a view illustrating a beacon processing method according to an exemplary embodiment of the present invention.

### MODE FOR CARRYING OUT THE DISCLOSURE

Hereinafter, exemplary embodiments of the present disclosure will be described in detail with reference to the accompanying drawings. In the description of the present disclosure, if it is considered that the specific description of related known configuration or function may cloud the gist of the present disclosure, the detailed description will be omitted. Further, hereinafter, exemplary embodiments of the present disclosure will be described. However, it should be understood that the technical spirit of the invention is not restricted or limited to the specific embodiments, but may be changed or modified in various ways by those skilled in the art to be carried out. Hereinafter, a projectile tracking method using a pseudo random noise code and an apparatus therefor proposed by the present invention will be described in detail with reference to drawings.

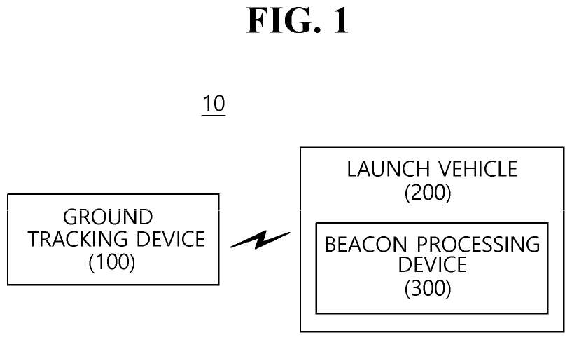

FIG. 1 is a block diagram schematically illustrating a projectile tracking system according to an exemplary embodiment of the present invention.

A projectile tracking system 10 according to the exemplary embodiment includes a ground tracking device 100 and a projectile (launch vehicle) 200. The projectile 200 includes a beacon processing device 300 which transmits and receives packets with the ground tracking device 100. The projectile tracking system 10 of FIG. 1 is an example so that all blocks illustrated in FIG. 1 are not essential components and in the other exemplary embodiment, some blocks included in the projectile tracking system 10 may be added, modified, or omitted.

The ground tracking device 100 refers to a device which is installed on the ground to track the projectile 200. Here, the ground tracking device 100 is desirably a radar device, but is not necessarily limited thereto and may be implemented by various types of devices as long as it can transmit a packet signal for tracking the projectile 200.

The ground tracking device 100 steers an antenna provided toward the projectile 200 and transmits a tracking packet signal to the projectile 200.

The ground tracking device 100 acquires a response packet signal which is transmitted from the beacon processing device 300 equipped in the projectile 200.

An operation of transmitting and receiving a tracking packet signal and a response packet signal is repeatedly performed between the ground tracking device 100 and the beacon processing device 300.

The ground tracking device 100 calculates a transmission/reception delay time using a packet reception time determined based on a timing error for the response packet signal. The ground tracking device 100 calculates the transmission/reception delay time using a value calculated by correlation.

The ground tracking device 100 calculates a distance from the projectile 200 using the transmission/reception delay time to track a flight trajectory of the projectile 200.

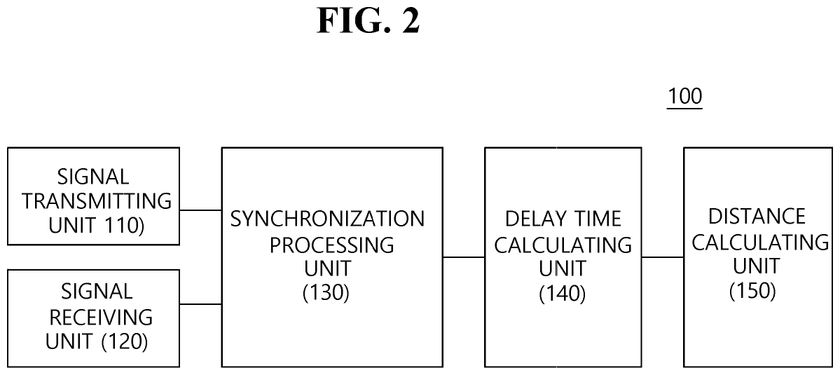

The ground tracking device 100 will be described in more detail with reference to FIG. 2.

The projectile 200 refers to a moving object which is launched from the ground to fly through a flight trajectory which has been set in advance or is set in real time. Here, the projectile 200 may be a guided flight vehicle, a satellite projectile, or a weapon vehicle, and may be various types of moving objects which can move in the air.

The projectile 200 includes a beacon processing device 300 to interwork with the ground tracking device 100. In the meantime, the configuration included in the projectile 200 for setting a flight trajectory and a propulsion operation is the same as the configuration of a general projectile so that a description thereof will be omitted.

The beacon processing device 300 refers to a device which is provided in the projectile 200 to transmit and receive a packet signal with the ground tracking device 100 to perform beacon communication.

The beacon processing device 300 acquires a tracking packet signal transmitted from the ground tracking device 100.

The beacon processing device 300 generates a response packet signal based on a pseudo random noise (PN) code included in the tracking packet signal to transmit the response packet signal to the ground tracking device 100. The beacon processing device 300 transmits a response packet signal including information related to the reception of the tracking packet signal to the ground tracking device 100.

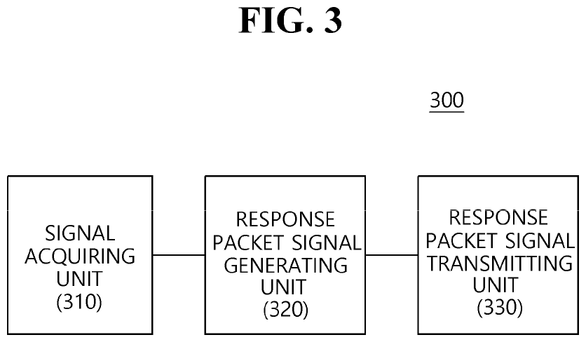

The beacon processing device 300 will be described in more detail with reference to FIG. 3.

FIG. 2 is a block diagram schematically illustrating a ground tracking device according to an exemplary embodiment of the present invention.

The ground tracking device 100 according to an exemplary embodiment includes a signal transmitting unit 110, a signal receiving unit 120, a synchronization processing unit 130, a delay time calculating unit 140, and a distance calculating unit 150. The ground tracking device 100 of FIG. 2 is an example so that all blocks illustrated in FIG. 2 are not essential components and in the other exemplary embodiment, some blocks included in the ground tracking device 100 may be added, modified, or omitted.

The ground tracking device 100 transmits a tracking packet signal to the projectile 200, acquires a response packet signal transmitted from the beacon processing device 300 equipped in the projectile 200, and calculates a distance from the projectile 200 based on the transmission/reception delay time calculated using a packet reception time determined based on a timing error of the response packet signal to track a flight trajectory of the projectile 200.

Hereinafter, components included in the ground tracking device 100 will be described.

The signal transmitting unit 10 transmits the tracking packet signal to the projectile 200.

The signal transmitting unit 110 transmits the tracking packet signal including a pseudo random noise (PN) code. Here, the pseudo random noise code is included in a preamble of the tracking packet signal. For example, the preamble of the tracking packet signal is a pseudo noise (PN) sequence with a period of N=2 m−1 which is generated by a linear feedback shift register (LFSR) having a predetermined length m and is modulated by binary phase shift keying (BPSK) to have a value of −1 or +1. Here, even though it is described that the pseudo random noise code is generated by LFSR, it is not necessarily limited thereto and may be generated in various manners.

The signal receiving unit 120 receives the response packet signal transmitted from the beacon processing device 300. Here, the signal receiving unit 120 receives a response packet signal including a pseudo random noise code.

The synchronization processing unit 130 calculates a timing error for the response packet signal and determines a packet reception time by performing the synchronization processing based on the timing error.

The synchronization processing unit 130 corrects and determines the packet reception time by subtracting a value calculated using a predetermined modulation symbol interval and the sample timing error from a reception time calculated as a timing when a correlation value for the response packet signal is maximum.

The synchronization processing unit 130 corrects the packet reception time by subtracting a value acquired by using a predetermined modulation symbol interval and the sample timing error from an initial packet reception time calculated as a timing when a correlation value of a previously stored reference pseudo random noise code and the pseudo random noise code included in the response packet signal is maximum.

For example, the synchronization processing unit 130 calculates a packet reception time corrected by subtracting a value obtained by multiplying a half (½) the predetermined modulation symbol interval (a sample timing interval) and the sample timing error.

The synchronization processing unit 130 may calculate a sample timing error based on a correlation value before a predetermined unit time based on a timing when the correlation value of the previously stored reference pseudo random noise code and the pseudo random noise code included in the response packet signal is maximum and a correlation value after a predetermined unit time based on a timing when the correlation value is maximum.

For example, the synchronization processing unit 130 calculates a sample timing error by multiplying a value obtained by subtracting a correlation value after a predetermined unit time from a correlation value before a predetermined unit time and a value calculated by multiplying a value obtained by subtracting a correlation value after a predetermined unit time from a correlation value before a predetermined unit time and a factor which makes linear within a predetermined range.

The factor which makes linear within a predetermined range is changed by a sequence length of a pseudo random noise code and a roll-off factor of a square-root cosine (SRC) filter of a node which transmits a packet. In other words, the factor which makes linear within a predetermined range is a factor which makes linear in the range of the sample timing error of −0.5 to +0.5 and varies depending on a sequence length N of the PN code and the roll-off factor of the SRC filter. The correlation value may be acquired from sample values which are stored in the form of a finite impulse response (FIR) filter, based on the preamble of the packet, by the node which receives the packet.

The synchronization processing unit 130 is configured to include a preamble correlator.

The preamble correlator of the synchronization processing unit 130 has a signal obtained by adding a noise to the transmission packet signal as an input and it is assumed that a phase or frequency offset is removed by a separate method. The preamble correlator calculates a correlation value γ(k) from 2N sample values stored in a filter memory in the form of FIR filters using Equation 1.

$$γ ( k ) = \vert {\sum }_{n = 0}^{N - 1} {r}_{k - 2 n} {P}_{n} \vert$$

Here, pₙ is a preamble modulated by BPSK.

At a time kₚ when the entire preamble is input to the preamble correlator, the correlation value is maximum so that the preamble is detected. Due to a characteristic of the pseudo random noise code and the SRC filter characteristic in a transmitter which transmits a packet, a correlation value γ(kₚ−1) before a predetermined unit time and a correlation value γ(kₚ+1) after a predetermined unit time are defined based on a correlation value γ(kₚ) of a time kₚ at which the correlation value is maximum and a time kₚ at which the correlation value is maximum.

When there is no sample timing error, in the synchronization processing unit 130, the correlation value before a predetermined unit time and the correlation value after a predetermined unit time have the same value.

In the meantime, when the sample timing error is larger than 0, the correlation value before a predetermined unit time is larger than the correlation value after a predetermined unit time and when the sample timing error is smaller than 0, the correlation value before a predetermined unit time is smaller than the correlation value after a predetermined unit time.

When there is a sample timing error, the packet reception time calculated as a timing when the correlation value is maximum has an error corresponding to a value obtained by multiplying a sample timing interval and a time when the packet is actually received and the sample timing error. Therefore, the synchronization processing unit 130 calculates a packet reception time corrected by subtracting a value obtained by multiplying a half (½) the predetermined modulation symbol interval (a sample timing interval) and the sample timing error.

When the synchronization processing unit 130 does not correct the sample timing error, the error of the packet reception time is a predetermined sample timing interval, but when the sample timing error is corrected, the error of the packet reception time becomes an error of the sample timing error. That is, the synchronization processing unit 130 corrects the packet reception time based on the sample timing error to minimize the error and the delay time calculating unit 140 calculates a transmission/reception delay time between the transmission time of the tracking packet signal and the packet reception time using a packet reception time with a minimized error.

In the meantime, the synchronization processing unit 130 further identifies a count code included in the response packet signal.

When a counting order of the count code does not match the counting order of the count code of the previous response packet signal, the synchronization processing unit 130 recalculates a sample timing error for the response packet signal.

When the sample timing error is recalculated, the synchronization processing unit 130 calculates an average of the sample timing error for the previous response packet signal and a recalculated sample timing error of the current response packet signal to correct the packet reception time.

The delay time calculating unit 140 calculates the transmission/reception delay time between the ground tracking device 100 and the projectile 200 based on the transmission time of the tracking packet signal and the packet reception time.

The delay time calculating unit 140 calculates the transmission/reception delay time using a first packet transmission time of the tracking packet signal, a first packet reception time when the beacon processing device 300 receives the tracking packet signal, a second packet transmission time of the response packet signal, and a second packet reception time when the ground tracking device 100 receives the response packet signal. Here, the second packet reception time is desirably a packet reception time corrected using the sample timing error.

In the meantime, the delay time calculating unit 140 assigns different weights to the first packet transmission time, the first packet reception time, the second packet transmission time, and the second packet reception time and calculates the transmission/reception delay time using the first packet transmission time, the first packet reception time, the second packet transmission time, and the second packet reception time each assigned with the weight. Here, the weight may be calculated using a magnitude of transmitted/received signal and a unique value or an importance value of a device which transmits or receives a signal (for example, the beacon processing device or the ground tracking device). For example, the weight may be a value calculated by multiplying a magnitude of the signal and the unique value or the importance value of the device which transmits/receives a signal.

The distance calculating unit 150 tracks the projectile by calculating a distance between the ground tracking device 100 and the projectile 200 based on the transmission/reception delay time. Specifically, the distance calculating unit 150 calculates the distance between the ground tracking device 100 and the projectile 200 by multiplying a propagation speed of the packet and the transmission/reception delay time.

The distance calculating unit 150 tracks the flight trajectory of the projectile 200 using the calculated distance.

The distance calculating unit 150 repeatedly calculates the distance between the ground tracking device 100 and the projectile 200 to form the flight trajectory of the projectile 200.

When the distance value which is continuously calculated exceeds a predetermined threshold value, the distance calculating unit 150 recalculates the distance between the ground tracking device 100 and the projectile 200 using a synchronization processing result (the packet reception time or the sample timing error) of the previous calculated distance value and the subsequent calculated distance value of the distance value. Here, the predetermined threshold value may be a maximum distance in which the projectile 200 can move within a predetermined time.

For example, the distance calculating unit 150 calculates an average of a sample timing error of the previous calculated distance value and a sample timing error of the subsequent calculated distance value, calculates an average of a packet reception time of the previous calculated distance value and a packet reception time of the subsequent calculated distance value, and corrects the average of the packet reception time using the average of the sample timing error, and then recalculates the distance between the ground tracking device 100 and the projectile 200.

FIG. 3 is a block diagram schematically illustrating a beacon processing device of a projectile according to an exemplary embodiment of the present invention.

The beacon processing device 300 according to the exemplary embodiment includes a signal acquiring unit 310, a response packet signal generating unit 320, and a response packet signal transmitting unit 330. The beacon processing device 300 of FIG. 3 is an example so that all blocks illustrated in FIG. 3 are not essential components and in the other exemplary embodiment, some blocks included in the beacon processing device 300 may be added, modified, or omitted.

The beacon processing device 300 acquires a tracking packet signal transmitted from the ground tracking device 100, generates a response packet signal based on the pseudo random noise (PN) code included in the tracking packet signal to transmit the response packet signal to the ground tracking device 100, and transmits a response packet signal including information related to the reception of the tracking packet signal to the ground tracking device 100.

Hereinafter, components included in the beacon processing device 300 will be described.

The signal acquiring unit 310 acquires a tracking packet signal from the ground tracking device 100.

The response packet signal generating unit 320 generates the response packet signal based on correlation processing of the pseudo random noise code included in the tracking packet signal.

The response packet signal generating unit 320 correlates the pseudo random noise code included in the tracking packet signal and the previously stored reference pseudo random noise code and performs the synchronization processing based on the correlation processing result.

The response packet signal generating unit 320 generates a response packet signal including a pseudo random noise code including a reception time of the tracking packet signal based on the synchronization processing result.

The response packet signal transmitting unit 330 transmits a pseudo random noise code based response packet signal to the ground tracking device 100. Here, the pseudo random noise code is included in a preamble of the tracking packet signal. For example, the preamble of the tracking packet signal is a pseudo random noise (PN) sequence with a period of N=2 m−1 which is generated by a linear feedback shift register (LFSR) having a predetermined length m and is modulated by binary phase shift keying (BPSK) to have a value of −1 or +1. Here, even though it is described that the pseudo random noise code is generated by LFSR, it is not necessarily limited thereto and may be generated in various manners.

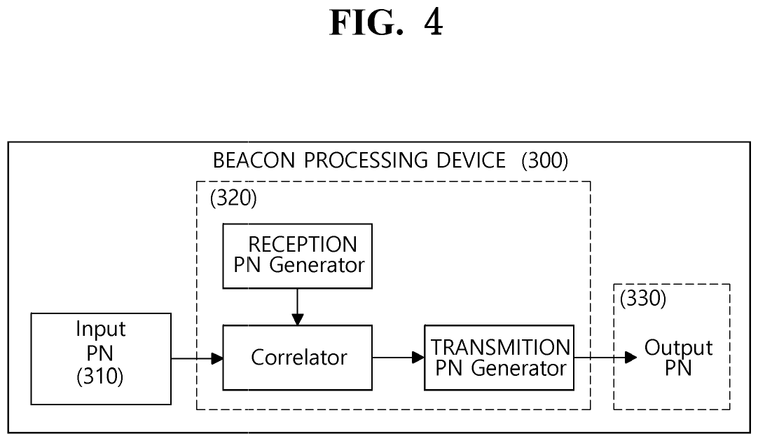

FIG. 4 is a block diagram schematically illustrating a hardware configuration of a beacon processing device according to an exemplary embodiment of the present invention.

As illustrated in FIG. 3, the beacon processing device 300 acquires a pseudo random noise code included in the tracking packet signal.

The beacon processing device 300 correlates the pseudo random noise code of the tracking packet signal and the predetermined reception pseudo random noise code and calculates a timing when the correlation value is maximum as a packet reception time of the tracking packet signal, and generates a pseudo random noise code of the response packet signal including the packet reception time.

The beacon processing device 300 transmits a pseudo random noise code based response packet signal including the packet reception time for the tracking packet signal to the ground tracking device 100.

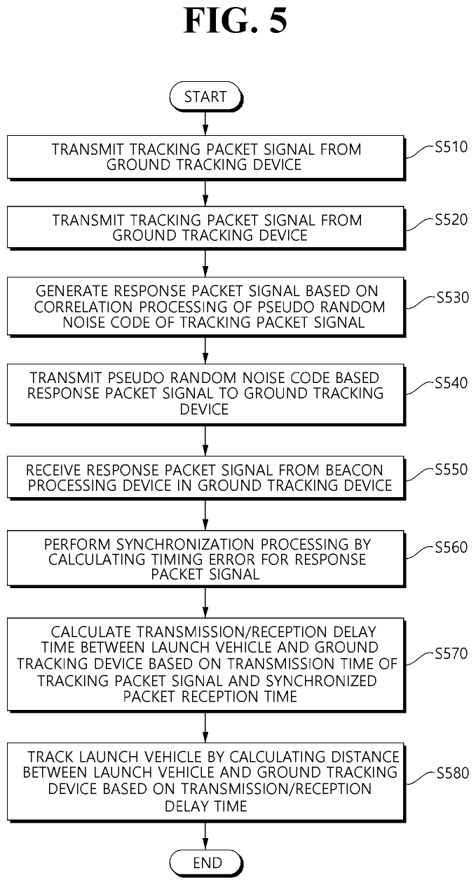

FIG. 5 is a flowchart for explaining a projectile tracking method according to an exemplary embodiment of the present invention.

The ground tracking device 100 transmits a tracking packet signal to the projectile 200 (S510). The ground tracking device 100 transmits the tracking packet signal including a pseudo random noise code.

The beacon processing device 300 included in the projectile 200 acquires a tracking packet signal from the ground tracking device 100 (S520).

The beacon processing device 300 generates the response packet signal based on correlation processing of the pseudo random noise code included in the tracking packet signal (S530).

The beacon processing device 300 correlates the pseudo random noise code included in the tracking packet signal and the previously stored reference pseudo random noise code and performs the synchronization processing based on the correlation processing result, and generates a response packet signal including a pseudo random noise code including a reception time of the tracking packet signal based on the synchronization processing result.

The beacon processing device 300 transmits a pseudo random noise code based response packet signal to the ground tracking device 100 (S540).

The ground tracking device 100 receives the response packet signal from the beacon processing device 300 (S550).

The ground tracking device 100 calculates a timing error for the response packet signal to perform the synchronization processing (S560).

The ground tracking device 100 corrects the packet reception time by subtracting a value acquired using a predetermined modulation symbol interval and the sample timing error from a packet reception time calculated as a timing when a correlation value for the response packet signal is maximum to perform the synchronization processing.

The ground tracking device 100 calculates the transmission/reception delay time between the ground tracking device 100 and the projectile 200 based on the transmission time of the tracking packet signal and the synchronized packet reception time (S570).

The ground tracking device 100 calculates the transmission/reception delay time using a first packet transmission time of the tracking packet signal, a first packet reception time when the beacon processing device 300 receives the tracking packet signal, a second packet transmission time of the response packet signal, and a second packet reception time when the ground tracking device 100 receives the response packet signal.

The ground tracking device 100 calculates the distance between the ground tracking device 100 and the projectile 200 based on the transmission/reception delay time to track the projectile 200 (S580).

The ground tracking device 100 calculates a distance between the ground tracking device 100 and the projectile 200 by multiplying a packet propagation speed and the transmission/reception delay time and tracks the flight trajectory of the projectile 200 using the calculated distance.

Even though in FIG. 5, it is described that the steps are sequentially performed, the present invention is not necessarily limited thereto. In other words, the steps illustrated in FIG. 5 may be changed or one or more steps may be performed in parallel so that FIG. 5 is not limited to a time-series order.

The projectile tracking method according to the exemplary embodiment described in FIG. 5 may be implemented by an application (or a program) and may be recorded in a terminal (or computer) readable recording medium. The recording medium which has the application (or program) for implementing the projectile tracking method according to the exemplary embodiment recorded therein and is readable by the terminal device (or a computer) includes all kinds of recording devices or media in which computing system readable data is stored.

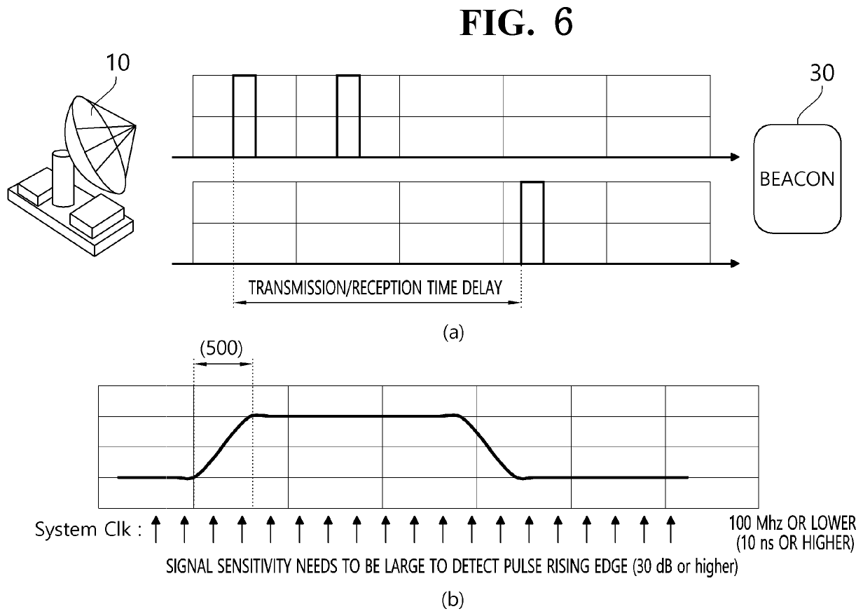

FIG. 6 is a view for explaining a beacon processing method of the related art.

As illustrated in FIG. 6 (a), a general ground tracking device 10 transmits a tracking packet signal (RF signal) modulated with a previously agreed double pulse toward a beacon processing device 30 mounted in a projectile.

The beacon processing device 30 receives a tracking packet signal and measures a pulse interval of pulses extracted from the tracking packet signal, and then checks whether the pulse is an agreed pulse. When it is confirmed that the pulse is the agreed pulse, the beacon processing device 30 transmits an RF signal having a frequency different from that of a tracking packet signal modulated with a single pulse as a response packet signal.

The ground tracking device 10 calculates a distance between the ground tracking device 10 and the projectile by means of time delay of the transmission/reception pulse (a tracking packet signal and a response packet signal).

As illustrated in FIG. 6 (b), the ground tracking device 10 calculates a response time of a continuous wave (CW) pulse by detecting a period 500 for the pulse rising time.

The ground tracking device 10 detects the pulse rising time with a precision of 10 ns or higher. The ground tracking device 10 detects a pulse rising edge in a condition in which a signal sensitivity is equal to or higher than a predetermined reference (for example, 30 dB) to determine a period for the pulse rising time.

That is, the ground tracking device 10 requires a peak power of a predetermined reference or higher for precision for the pulse rising time.

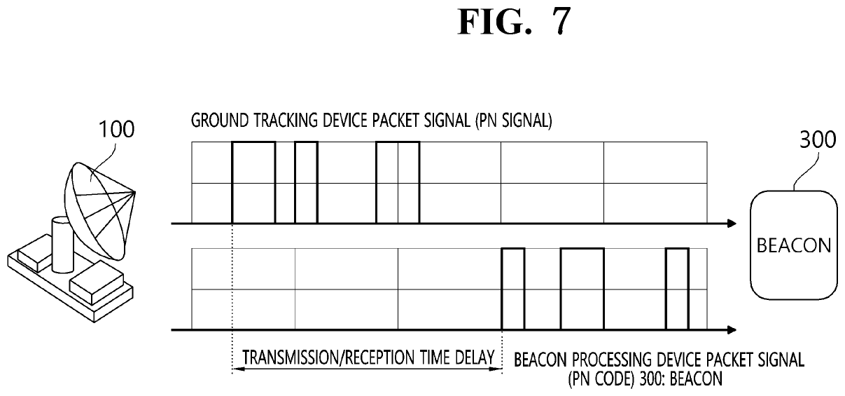

FIG. 7 is a view illustrating a beacon processing method according to an exemplary embodiment of the present invention.

The beacon processing device 300 is a device which is mounted in the projectile 200, receives a tracking packet signal which is encrypted by a pseudo random noise code to be transmitted, from the ground tracking device 100, and transmits the response packet signal corresponding to the tracking packet signal to the ground.

The ground tracking device 100 receives the response packet signal from the beacon processing device 300 and calculates a transmission/reception delay time using a packet reception time determined based on a timing error for the response packet signal. The ground tracking device 100 calculates the transmission/reception delay time using a value calculated by correlation processing. The ground tracking device 100 calculates a distance from the projectile 200 using the transmission/reception delay time to track a flight trajectory of the projectile 200.

The projectile tracking system 10 according to the exemplary embodiment is a system which transmits/receives a pseudo random noise code, rather than transmits/receives a pulse in the existing beacon method.

The projectile tracking system 10 according to the exemplary embodiment determines a time stamp for the response packet signal using synchronization processing (including symbol synchronization and timing error) which uses the correlation processing of the pseudo random noise code.

The projectile tracking system 10 does not need to increase a signal-to-noise ratio (SNR) of the packet signal to precisely transmit/receive the packet. When the SNR of 10 dB, 10 Mbps, and 64 PN are used, the projectile tracking system 10 may implement the precision of a normal double pulse based beacon system and performs the packet processing with a synchronization precision of 100 nm and a PN timing error precision of

$$1.14 m = 3.8 ns ( \frac{1.14 m}{3 \times {10}^{8} m / s} \times {10}^{9} ) .$$

It will be appreciated that various exemplary embodiments of the present disclosure have been described herein for purposes of illustration, and that various modifications and changes may be made by those skilled in the art without departing from the scope and spirit of the present invention. Accordingly, the exemplary embodiments of the present disclosure are not intended to limit but to describe the technical spirit of the present invention and the scope of the technical spirit of the present invention is not restricted by the exemplary embodiments. The protective scope of the embodiment of the present disclosure should be construed based on the following claims, and all the technical concepts in the equivalent scope thereof should be construed as falling within the scope of the embodiment of the present disclosure.

<Explanation of Reference Numerals and Symbols>

| | | | |
|---|---|---|---|
| 10: | Projectile tracking system | | |
| 100: | Ground tracking device | | |
| 110: | Signal transmitting unit | 120: | Signal receiving unit |
| 130: | Synchronization processing unit | 140: | Delay time calculating unit |
| 150: | Distance calculating unit | | |
| 200: | Projectile | | |
| 300: | Beacon processing device | | |
| 310: | Signal acquiring unit | 320: | Response packet signal generating unit |

| | |
|---|---|
| 330: | Response packet signal transmitting unit |

1. A projectile tracking system using a pseudo random noise code, comprising:
a beacon processing device which is provided in a projectile to acquire a tracking packet signal and generates and transmits a response packet signal based on a pseudo random noise code included in the tracking packet signal; and
a ground tracking device which transmits the tracking packet signal to the projectile, acquires the response packet signal, calculates a transmission/reception delay time using a packet reception time determined based on a timing error for the response packet signal, and calculates a distance from the projectile using the transmission/reception delay time to track a flight trajectory of the projectile.

2. The projectile tracking system of claim 1, wherein the beacon processing device includes:
a signal acquiring unit which acquires the tracking packet signal from the ground tracking device;
a response packet signal generating unit which generates a response packet signal based on correlation processing of the pseudo random noise code included in the tracking packet signal; and
a response packet signal transmitting unit which transmits the response packet signal based on the pseudo random noise code to the ground tracking device.

3. The projectile tracking system of claim 2, wherein the response packet signal generating unit correlates a pseudo random noise code included in the tracking packet signal and a previously stored reference pseudo random noise code and when it is confirmed that the correlation processing result is the same code, generates the response packet signal including the pseudo random noise code.

4. The projectile tracking system of claim 1, wherein the ground tracking device includes:
a signal transmitting unit which transmit the tracking packet signal including a pseudo random noise code to the projectile;
a signal receiving unit which receives the response packet signal from the beacon processing device;
a synchronization processing unit which calculates a timing error for the response packet signal and performs the synchronization processing based on the timing error to determine a packet reception time;
a delay time calculating unit which calculates a transmission/reception delay time between the projectile and the ground tracking device based on a transmission time of the tracking packet signal and the packet reception time; and
a distance calculating unit which calculates a distance between the projectile and the ground tracking device based on the transmission/reception delay time to track the projectile.

5. The projectile tracking system of claim 4, wherein the synchronization processing unit corrects and determines the packet reception time by subtracting a value calculated using a predetermined modulation symbol interval and the sample timing error from a reception time calculated at a timing when a correlation value for the response packet signal is maximum.

6. The projectile tracking system of claim 5, wherein the synchronization processing unit calculates the timing error based on a correlation value before a predetermined unit time based on a time when the correlation value is maximum and a correlation value after a predetermined unit time based on a time when the correlation value is maximum.

7. The projectile tracking system of claim 4, wherein the delay time calculating unit calculates the transmission/reception delay time using a first packet transmission time of the tracking packet signal, a first packet reception time when the beacon processing device receives the tracking packet signal, a second packet transmission time of the response packet signal, and a second packet reception time when the ground tracking device receives the response packet signal and the second packet reception time is a packet reception time which is corrected using the timing error.

8. The projectile tracking system of claim 7, wherein the distance calculating unit calculates a distance between the projectile and the ground tracking device by multiplying a packet propagation speed and the transmission/reception delay time.

9. The projectile tracking system of claim 4, wherein the synchronization processing unit further checks a count code included in the response packet signal and when an order of the count code does not match an order of the count code of the previous response packet signal, recalculates the timing error for the response packet signal.

10. A projectile tracking method using a pseudo random noise code in a projectile tracking system including a ground tracking device and a projectile including a beacon processing device, the method comprising:
transmitting a tracking packet signal from the ground tracking device to the projectile;
acquiring the tracking packet signal by the beacon processing device;
generating and transmitting a response packet signal based on a pseudo random noise code included in the tracking packet signal in the beacon processing device;
acquiring the response packet signal in the ground tracking device; and
tracking a flight trajectory of the projectile by calculating a transmission/reception time using a packet reception time determined based on a timing error for the response packet signal and calculating a distance from the projectile using the transmission/reception delay time in the ground tracking device.

11. The projectile tracking method of claim 10, wherein the generating and transmitting of a response packet signal includes:
a response packet signal generating step of generating a response packet signal based on correlation processing of the pseudo random noise code included in the tracking packet signal; and
a response packet signal transmitting step of transmitting the response packet signal based on the pseudo random noise code to the ground tracking device, and
in the response packet signal generating step, a pseudo random noise code included in the tracking packet signal and a previously stored reference pseudo random noise code are correlated and when it is confirmed that the correlation processing result is the same code, the response packet signal including a pseudo random noise code is generated.

12. The projectile tracking method of claim 10, wherein the tracking of a flight trajectory of the projectile includes:
a synchronization processing step of calculating a timing error for the response packet signal and performing the synchronization processing based on the timing error to determine a packet reception time;
a delay time calculating step of calculating a transmission/reception delay time between the projectile and the ground tracking device based on a transmission time of the tracking packet signal and the packet reception time; and
a distance calculating step of calculating a distance between the projectile and the ground tracking device based on the transmission/reception delay time to track the projectile.

13. The projectile tracking method of claim 12, wherein in the synchronization processing step, the packet reception time is corrected and determined by subtracting a value calculated using a predetermined modulation symbol interval and the sample timing error from a reception time calculated at a timing when a correlation value for the response packet signal is maximum.

14. The projectile tracking method of claim 13, wherein in the synchronization processing step, the timing error is calculated based on a correlation value before a predetermined unit time based on a time when the correlation value is maximum and a correlation value after a predetermined unit time based on a time when the correlation value is maximum.
